(19) United States
(12) Patent Application Publication
(10) Pub. No.: US 2026/0004418 A1
(43) Pub. Date: Jan. 1, 2026

(54) Appearance Inspection System and Appearance Inspection Method

(71) Applicant: Hitachi-GE Nuclear Energy, Ltd., Hitachi-shi (JP)

(72) Inventors: Sho YAMAGUCHI, Hitachi-shi (JP); Naoki HOSOYA, Tokyo (JP); Yutaka ARAI, Hitachi-shi (JP); Yoshiaki NAGASHIMA, Hitachi-shi (JP); Riku NAKATA, Hitachi-shi (JP)

(21) Appl. No.: 19/208,685

(22) Filed: May 15, 2025

(30) Foreign Application Priority Data
Jun. 27, 2024 (JP) 2024-103998

(51) Int. Cl. G06T 7/00; G21C 17/00

(52) U.S. Cl. CPC G06T 7/001; G06T 2200/24; G06T 2207/20081; G06T 2207/20084; G21C 17/00

(57) ABSTRACT

An appearance inspection apparatus includes: an annotation unit that associates annotation information indicating whether a defect of a structure is normal with an input image to be used for an appearance inspection of the structure, the information being determined by a user based on the input image; a learning unit that generates a trained model by deep learning using the information and the input image associated with the information with respect to an initially-set trained model; and a defect inference unit that outputs a result obtained by inferring the defect based on the input image using the trained model generated by the learning unit, in which the annotation unit associates the information with the input image for which the result is different from a result of the determination made by the user for the input image to cause the learning unit to relearn the trained model.

### BACKGROUND

### Technical Field

The present invention relates to an appearance inspection system and an appearance inspection method.

### Related Art

Conventionally, for an inspection in a reactor of a nuclear power plant, an appearance inspection has been carried out by an inspector visually checking a video acquired by a camera and determining whether there is a flaw. The visibility of the video deteriorates due to darkness and noise on the screen caused by radiation in the reactor, placing a heavy burden on the inspector. Therefore, a technique for reducing a burden on an inspector by presenting a location of a flaw to the inspector using machine learning in detecting and identifying a defect has been used.

Patent Literature 1 discloses that “a machine learning device included in an appearance inspection apparatus includes: a state observation unit that observes a state variable including normal product image data indicating an image of a normal product and comparison image data indicating an image of a product to be compared with the normal product; a label data acquisition unit that acquires label data including classification data indicating a label (normal product or defective product) for the image of the product to be compared; and a learning unit that learns a classification for a difference between the image of the normal product and the image of the product to be compared (normal product or defective product) using the state variable S and the label data”.

### CITATION LIST

### Patent Literature

Patent Literature 1: JP 2019-095217 A

### SUMMARY

Normally, training a neural network that classifies objects appearing in images requires a huge number of images and man-hours for labeling all the images to determine whether they have defects. In addition, the shapes of structures to be inspected in nuclear power plants are diverse. For this reason, it is necessary to learn subjects to be inspected in order to detect suspected defects, which takes a long time. Further, it is necessary to identify defects to determine whether the detected suspected defects are actual defects or patterns such as welding marks. To identify defects, it is necessary to separately learn defect shapes, which further increases the learning time.

An advantage of using machine learning is that progressive learning can be performed. For example, progressive learning can be performed by causing AI to perform machine learning using flaw detection images obtained by actually detecting flaws as teacher data. However, if all of the obtained data is used as teacher data, not only will the learning time increase, but there is also a risk of over-learning, which may lead to a decrease in defect detection accuracy.

The present invention has been made in view of such a situation, and an object of the present invention is to generate a trained model using data for improving the trained model among data obtained by appearance inspection.

An appearance inspection system according to the present invention includes: an annotation unit that associates annotation information indicating whether a defect of a structure is normal with an input image to be used for an appearance inspection of the structure, the annotation information being determined by a user based on the input image; a learning unit that generates a trained model by deep learning using the annotation information and the input image associated with the annotation information with respect to an initially-set trained model; and a defect inference unit that outputs an inference result obtained by inferring the defect based on the input image using the trained model generated by the learning unit, in which the annotation unit associates the annotation information with the input image for which the inference result is different from a result of the determination made by the user for the input image to cause the learning unit to relearn the trained model.

According to the present invention, a trained model can be generated using data for improving the trained model among data obtained by appearance inspection.

Problems, configurations, and effects other than those described above will be apparent from the following description of embodiments.

### BRIEF DESCRIPTION OF DRAWINGS

FIG. 1 is a diagram illustrating an example of an overall configuration and an outline of processing of an appearance inspection system according to a first embodiment of the present invention;

FIG. 2 is a block diagram illustrating an example of an internal configuration of an appearance inspection apparatus according to the first embodiment of the present invention;

FIG. 3 is a block diagram illustrating an example of a detailed internal configuration of a defect detection unit according to the first embodiment of the present invention;

FIG. 4 is a diagram that outlines image restoration processing and difference determination processing performed by the defect detection unit according to the first embodiment of the present invention;

FIG. 5 is a block diagram illustrating examples of detailed internal configurations of a defect identification unit and an annotation unit according to the first embodiment of the present invention;

FIG. 6 is a diagram illustrating an example of defect identification inference processing performed by an identification inference unit according to the first embodiment of the present invention;

FIG. 7 is a diagram illustrating an example of inspector determination processing performed by the annotation unit according to the first embodiment of the present invention;

FIG. 8 is a flowchart illustrating an example of appearance inspection processing performed by the appearance inspection apparatus according to the first embodiment of the present invention;

FIG. 9 is a block diagram illustrating an example of a hardware configuration of a computer according to the first embodiment of the present invention;

FIG. 10 is a block diagram illustrating an example of an internal configuration of an appearance inspection apparatus according to a second embodiment of the present invention;

FIG. 11 is a block diagram illustrating an example of an internal configuration of a defect detection unit according to the second embodiment of the present invention;

FIG. 12 is a diagram that outlines image restoration processing, difference determination processing, and matching degree calculation processing performed by the defect detection unit according to the second embodiment of the present invention; and

FIG. 13 is a block diagram illustrating examples of detailed internal configurations of a defect identification unit and an annotation unit according to the second embodiment of the present invention.

### DETAILED DESCRIPTION

Hereinafter, embodiments of the present invention will be described with reference to the accompanying drawings. In the present specification and the drawings, components having substantially the same functions or configurations are denoted by the same reference numerals, and redundant explanations will be omitted.

### First Embodiment

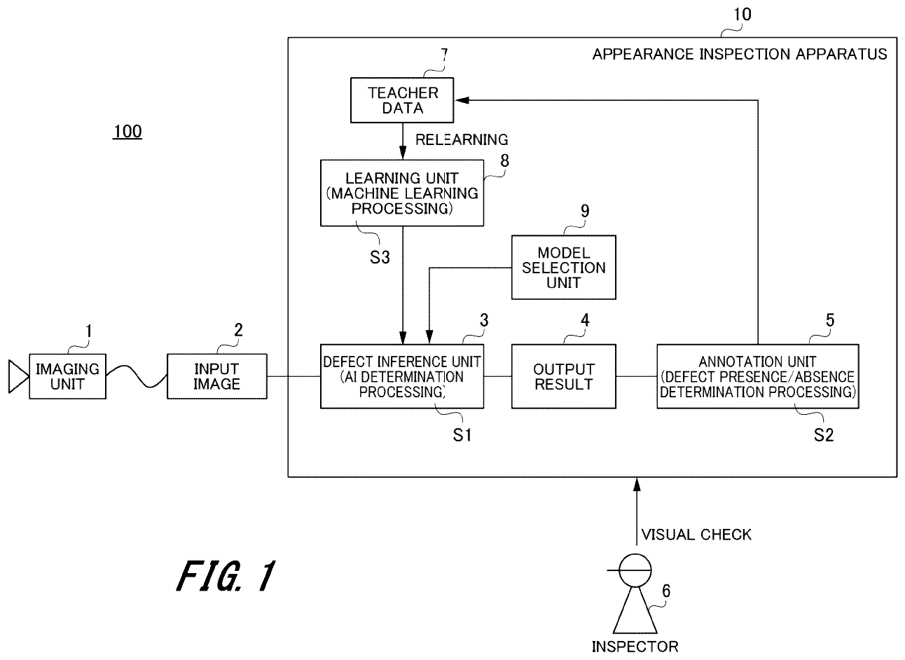

FIG. 1 is a diagram illustrating an example of an overall configuration and an outline of processing of an appearance inspection system 100 according to the first embodiment.

The appearance inspection system 100 includes an imaging unit 1 and an appearance inspection apparatus 10.

For example, the imaging unit 1 outputs image data of an image or a video obtained by imaging an appearance of a structure of a nuclear power plant. The image data is input to the appearance inspection apparatus 10 as input images 2.

The input images 2 may include flaw detection data including an image of a defect. In addition, the input images 2 may be stored in a database (not illustrated in FIG. 1) and appropriately read from the appearance inspection apparatus 10. The appearance inspection apparatus 10 inspects whether an image of a crack or the like in a structure is included in the input images 2, and evaluates the input images 2.

In the appearance inspection apparatus 10, artificial intelligence (AI) determination processing (S1) is performed by a defect inference unit 3 using AI. The AI determination processing (S1) is a step in which the defect inference unit 3 determines whether there is a defect based on the input images 2. The defect inference unit 3 outputs an inference result obtained by inferring a defect based on the input images 2 using a trained model generated by a learning unit 8.

The AI that performs the AI determination processing (S1) uses a trained model that has learned teacher data 7 in advance through machine learning processing (S3). For example, a different trained model is used for each structure to be subjected to an appearance inspection. Therefore, before the appearance inspection, an inspector 6 selects a trained model that has learned the structure to be subjected to the appearance inspection through a model selection unit 9. The model selection unit 9 selects a defect detection model and a defect identification model to be used for an appearance inspection for each structure.

When the AI determination processing (S1) using the trained model selected by the model selection unit 9 is completed, an output result 4 is output as an example of the inference result. Examples of the data of the output result 4 include a result of determining whether there is a defect using the defect inference unit 3, an image in which a defective portion is emphasized with respect to the input images 2, and the like.

The inspector 6 is an example of a user who performs an appearance inspection of a structure using the appearance inspection apparatus 10. The inspector 6 performs defect presence/absence determination processing (S2) of visually checking whether there is a defect based on the output result 4 and the input images 2. An annotation unit 5 associates annotation information indicating whether the defect of the structure is normal, which is determined by the user based on the input images 2 used for the appearance inspection of the structure, with the input images 2. Therefore, the defect presence/absence determination processing (S2) is a step of associating the annotation information with the input images 2 using the annotation unit 5 operated by the inspector 6. The result of determination made by the inspector 6 in the defect presence/absence determination processing (S2) is a final result of determining whether there is a defect.

A part of the result of the defect presence/absence determination processing (S2) is teacher data 7 to be used for relearning in the machine learning processing (S3). Here, input images 2 for which the output result 4 as to whether there is a defect in the input images 2 in the AI determination processing (S1) and the output result 4 as to whether there is a defect in the input images 2 determined by the inspector 6 in the defect presence/absence determination processing (S2) are different is used as the teacher data 7.

The learning unit 8 generates a trained model through deep learning using the annotation information and the input images 2 associated with the annotation information with respect to the initially-set trained model. Therefore, in the machine learning processing (S3), the learning unit 8 performs relearning using the teacher data 7 and stores the trained model. The learning unit 8 can improve the trained model by relearning using the teacher data 7 including the annotation information for improving the trained model. The defect inference unit 3 performs the AI determination processing (S1) again using the trained model for which relearning has been completed.

In this manner, in the appearance inspection apparatus 10, the AI determination processing (S1), the defect presence/absence determination processing (S2), and the machine learning processing (S3) are repeatedly performed. As a result, AI determination processing (S1) can be performed using the trained model for which progressive learning has been performed in the machine learning processing (S3).

In addition, the annotation unit 5 associates the annotation information with the input images for which the inference result of the output result 4 is different from the result of the determination made by the user with respect to the input images, and causes the learning unit 8 to relearn the trained model.

Note that, at the time of initially setting the appearance inspection apparatus 10, there is no trained model, so it is necessary to generate a trained model. Therefore, the inspector 6 visually checks the input images 2, and the annotation unit 5 associates the annotation information with the input images 2. The learning unit 8 performs machine learning processing (S3) based on the input images 2 associated with the annotation information to generate a trained model. The defect inference unit 3 performs AI determination processing (S1) using the generated trained model.

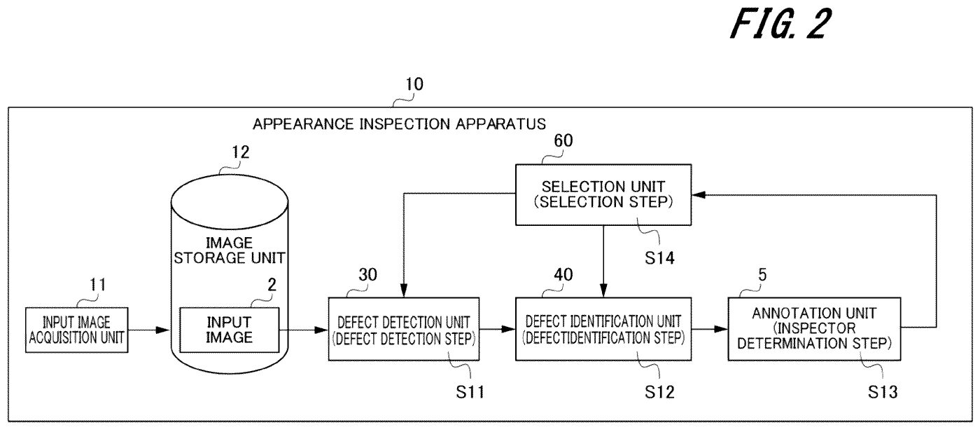

Next, an example of an internal configuration and an example of an operation of the appearance inspection apparatus 10 according to the first embodiment will be described with reference to FIGS. 2 to 10.

FIG. 2 is a block diagram illustrating an example of an internal configuration of the appearance inspection apparatus 10.

The appearance inspection apparatus 10 includes an input image acquisition unit 11, an image storage unit 12, a defect detection unit 30, a defect identification unit 40, an annotation unit 5, and a selection unit 60. As illustrated in FIG. 2, the defect detection unit 30 performs a defect detection step (S11), the defect identification unit 40 performs a defect identification step (S12), the annotation unit 5 performs an inspector determination step (S13), and the selection unit 60 performs a selection step (S14). The defect detection step (S11) and the defect identification step (S12) are performed by AI. The inspector determination step (S13) and the selection step (S14) are performed by the inspector 6.

First, the input image acquisition unit 11 acquires input images 2 from the imaging unit 1 illustrated in FIG. 1.

The image storage unit 12 is a database that stores a plurality of input images, and is an example of an input image storage unit. The image storage unit 12 stores the input images 2 acquired by the input image acquisition unit 11 in such a manner that the defect detection unit 30 can read the input images 2. In the image storage unit 12, the input images 2 are classified and stored for each main component of the nuclear power plant. The image storage unit 12 classifies and stores the input images 2 for each of the nuclear power plants in different regions.

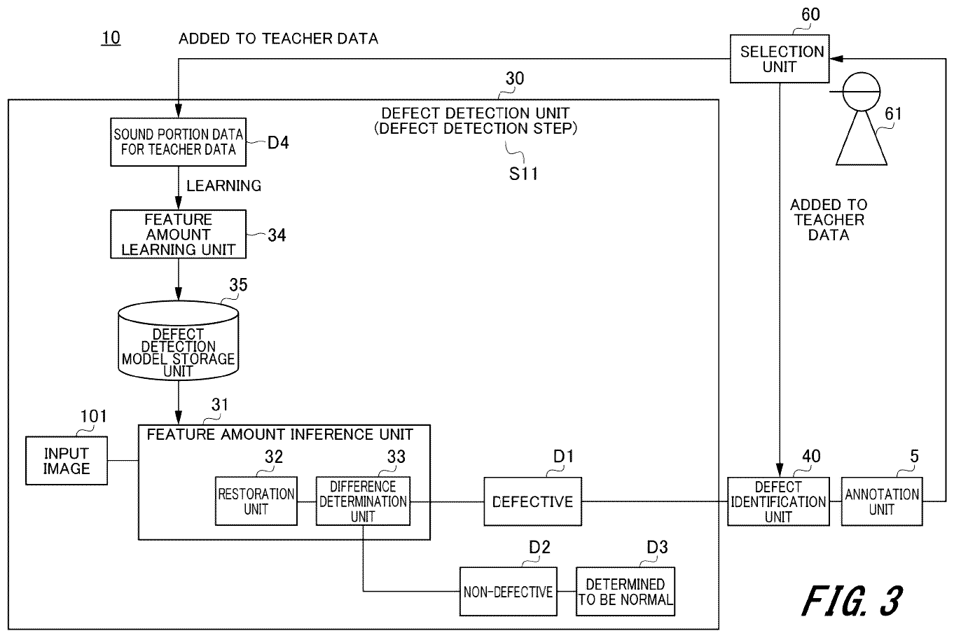

The defect detection unit 30 reads one input image 101 (see FIG. 3 to be described later) from the plurality of input images 2 stored in the image storage unit 12, and performs a defect detection step (S11) in which the trained model detects a defect of a structure based on the input image 101. The input image 101 is also called a flaw detection image because it is used to identify whether there is a defect such as a flaw. In the defect detection step (S11), whether a defect is included in the input image 101 is identified by inference processing using a defect detection model.

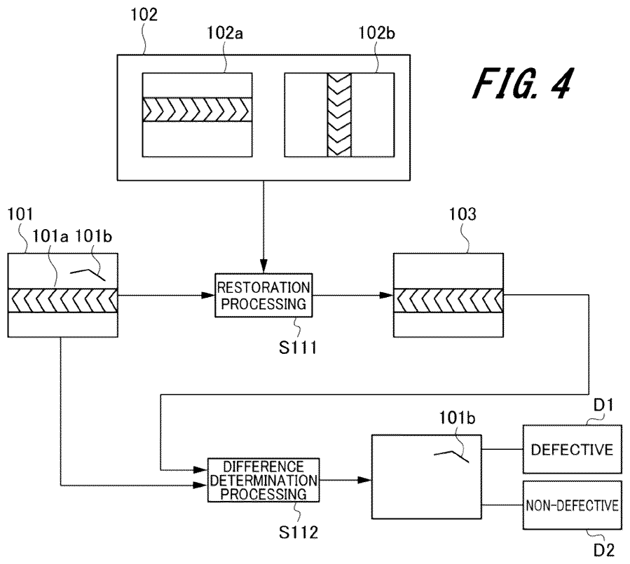

However, the input image 101 also includes an image that cannot be said to be a defect, such as a shadow, a reflection, or a scratch that does not affect the quality, in addition to the defect. Therefore, it is necessary for the defect identification unit 40 to identify what kind of defect the defect detected by the defect detection unit 30 is actually in the next process. The processing of the defect detection unit 30 will be described in detail later with reference to FIGS. 3 and 4.

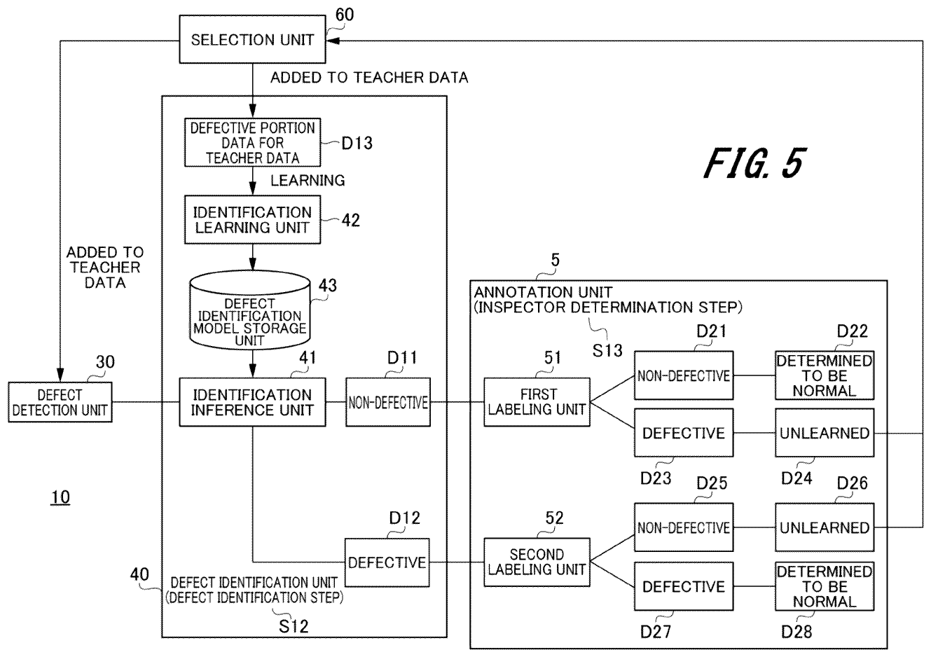

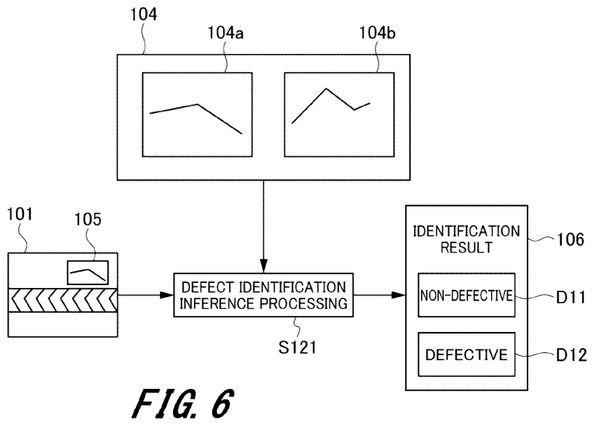

The defect identification unit 40 performs a defect identification step (S12) in which the trained model identifies whether there is a defect based on the input image 101 determined to have a defect by the defect detection unit 30. In the defect identification step (S12), whether the defect is actually a defect is identified by inference processing using the defect identification model. A defect identification result is output to the annotation unit 5. The processing of the defect identification unit 40 will be described in detail later with reference to FIGS. 5 and 6.

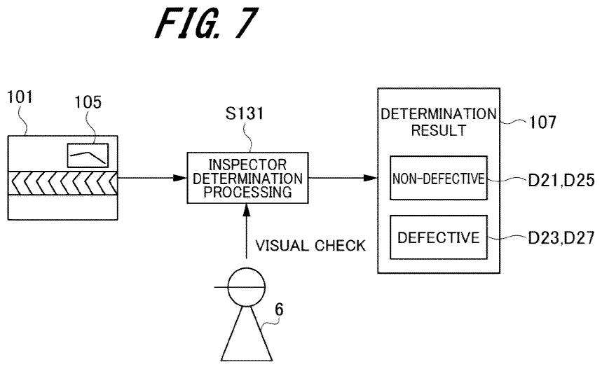

The annotation unit 5 performs an inspector determination step (S13) in which the inspector 6 visually checks the input image 101 to perform an appearance inspection of the structure. In the inspector determination step (S13), it is determined whether the defect identification result in the defect identification step (S12) is an actual defect. When a result of the inspector 6 recognizing the input image 101 and associating whether there is a defect is different from the defect identified by the defect identification unit 40, the annotation unit 5 associates annotation information with the input image 101. The result of the determination made by the inspector 6 is reflected in the learning processing in the defect detection unit 30 and the defect identification unit 40. The processing of the annotation unit 5 will be described in detail later with reference to FIG. 7.

The selection unit 60 selects an output destination for reflecting the result of the determination made by the inspector 6 in the annotation unit 5 in learning processing in at least one of the defect detection unit 30 and the defect identification unit 40. The processing of the selection unit 60 is performed not only by the inspector 6 but also by an engineer 61 or the like who understands the features of AI. Therefore, based on the annotation information associated with the input image 101, the selection unit 60 selects the input image 101 to be learned by at least one of a feature amount learning unit 34 and an identification learning unit 42, and the feature amount learning unit 34 and the identification learning unit 42 to learn the input image 101 based on an instruction from the engineer 61.

FIG. 3 is a block diagram illustrating an example of a detailed internal configuration of the defect detection unit 30.

The defect detection unit 30 includes a feature amount inference unit 31, a feature amount learning unit 34, and a defect detection model storage unit 35. The feature amount inference unit 31 includes a restoration unit 32 and a difference determination unit 33. In the defect detection step (S11), the feature amount inference unit 31 evaluates whether there is a suspected defect in the input image 101 using the restoration unit 32 and the difference determination unit 33. Then, the defect detection unit 30 detects a defect using a defect detection model for detecting a defect as a trained model.

The feature amount inference unit 31 infers a feature amount of the input image 101 read from the image storage unit 12 illustrated in FIG. 2. The feature amount is a feature appearing in the appearance of the structure, and corresponds to, for example, a pattern of the structure. The feature amount inference unit 31 uses a defect detection model output by the feature amount learning unit 34 that has learned a sound portion (a portion that has been confirmed not to include a defect or the like) in each structure. A plurality of defect detection models, which are examples of trained models that have been trained for the respective structures, are stored in the defect detection model storage unit 35. The feature amount inference unit 31 reads a defect detection model suitable for a structure of which a feature amount is to be inferred from the defect detection model storage unit 35, and uses the read defect detection model in detecting a defect of the structure.

As a defect evaluation method using the feature amount inference unit 31, for example, the restoration unit 32 outputs a restored image 103 (see FIG. 4 to be described later) using image restoration processing through an auto encoder or the like, and the difference determination unit 33 takes a difference between the original input image 101 before the restoration processing and the restored image 103 after the restoration processing.

Here, examples of image restoration processing performed by the restoration unit 32 and difference determination processing performed by the difference determination unit 33 will be described with reference to FIG. 4.

FIG. 4 is a diagram that outlines the image restoration processing and difference determination processing performed by the defect detection unit 30 according to the first embodiment. Both the restoration unit 32 and the difference determination unit 33 can execute the defect detection step (S11) in combination with the defect detection model. In FIG. 4, the defect detection step (S11) is illustrated in detail.

The input image 101 includes, for example, a pattern 101a or the like of a welding line and a crack 101b or the like. The pattern 101a may be present in the structure, but the crack 101b should not be present in the structure. However, even if the crack 101b looks like a defect, it may be a reflection of light when the imaging unit 1 captures an image.

The defect detection unit 30 outputs a restored image 103 restored from the input image 101 based on sound portion data for teacher data including a sound portion without a defect. Therefore, in the restoration unit 32, restoration processing (S111) is performed by machine learning, for example, using an auto encoder or the like. In the machine learning of the restoration processing (S111), pattern restoration processing is performed on the input image 101, for example, using the pattern 101a of the welding line or the like in each photographed portion shown in the teacher data 102, the pattern 101a having been learned in advance as the teacher data 102. At this time, the teacher data 102 does not include defect information.

The restored image 103 is an example of an output image after the restoration processing (S111) is performed on the input image 101. The teacher data 102 not including defect information is used for the machine learning in the restoration processing (S111). The teacher data 102 includes an image 102a showing a welding line in the horizontal direction and an image 102b showing a welding line in the vertical direction in FIG. 4. Both of the images 102a and 102b show sound portions of the structure.

Since the teacher data 102 not including defect information is used for the machine learning in the restoration processing (S111), an image of a defect is not restored. Accordingly, the restored image 103 does not include an image of a defect. Therefore, the difference determination unit 33 determines a difference by comparing the restored image 103 with the input image 101, thereby making it possible to extract an image of a suspected defect.

The difference determination unit 33 performs difference determination processing (S112) of determining a difference between the restored image 103 output by the restoration unit 32 and the input image 101 before the image restoration processing. The difference determination unit 33 determines the image to be defective D1 when there is a difference (a crack 101b illustrated in FIG. 4) in the image, and determines the image to be non-defective D2 when there is no difference in the image.

The feature amount inference unit 31 detects a defect from the input image 101 based on the difference.

Referring back to FIG. 3, the description will continue.

When the difference determination unit 33 determines to be non-defective D2, the input image is determined to be normal D3 and the appearance inspection ends. However, the input image 101 determined to be normal D3 as a conservative inspection may be displayed on a screen, and the inspector 6 may check whether there is a pattern 101a or a crack 101b in the input image 101 again. The input image 101 determined to be defective D1 by the defect detection unit 30 and the restored image 103 are output to the defect identification unit 40 and evaluated by the defect identification unit 40.

Using sound portion data for teacher data D4 selected by the selection unit 60, the feature amount learning unit 34 learns a feature amount of the sound portion and generates a defect detection model. The sound portion data for teacher data D4 is, for example, the teacher data 102 illustrated in FIG. 4. When there is a defect detection model for an existing structure, the feature amount learning unit 34 updates the existing defect detection model. The defect detection model is updated, for example, by changing the weights between layers in the neural network.

That is, the learning unit 8 illustrated in FIG. 1 includes a feature amount learning unit 34 that causes the defect detection model to learn the feature amount of the sound portion using the input image 101 to which the annotation information that the defect detection model has not learned is added as the sound portion data for teacher data.

The defect detection model storage unit 35 is an example of a database, and stores the defect detection model generated by the feature amount learning unit 34. As described above, the defect detection model stored in the defect detection model storage unit 35 is appropriately read by the feature amount inference unit 31 and used for detecting a defect.

FIG. 5 is a block diagram illustrating examples of detailed internal configurations of the defect identification unit 40 and the annotation unit 5.

First, an example of an internal configuration of the defect identification unit 40 and the defect identification inference processing (S121) will be described. The defect identification unit 40 includes an identification inference unit 41, an identification learning unit 42, and a defect identification model storage unit 43. The defect identification unit 40 detects a defect using a defect identification model for identifying a defect as a trained model.

The identification inference unit 41 identifies a defect in the input image 101 determined to be defective based on defective portion data for teacher data including a defective portion where there is the defect, and associates annotation information indicating whether there is a defect with the input image 101. For example, the identification inference unit 41 determines whether an image of a suspected defective portion correctly indicates a defect based on the input image 101 determined to be defective D1 by the difference determination unit 33, which is illustrated in FIG. 3. Therefore, the identification inference unit 41 determines whether the crack 101b, which is a different portion illustrated in FIG. 4, is a defect.

The input image 101 determined to be non-defective D11 by the defect identification unit 40 is output to the annotation unit 5, and is visually evaluated by the inspector 6 in a first labeling unit 51 of the annotation unit 5. Similarly, the input image 101 determined to be defective D12 by the defect identification unit 40 is output to the annotation unit 5, and is visually evaluated by the inspector 6 in a second labeling unit 52 of the annotation unit 5.

Here, an outline of processing performed by the identification inference unit 41 of the defect identification unit 40 will be described.

FIG. 6 is a diagram illustrating an example of defect identification inference processing (S121) performed by the identification inference unit 41.

In the input image 101, emphasis processing is performed on a portion suspected of having a defect (referred to as a suspected portion) with respect to the input image 101 illustrated in FIG. 2. The emphasis processing is, for example, processing in which the feature amount inference unit 31 attaches an emphasized portion 105 shown in a frame around the image of the crack, which is a suspected defective portion.

In the defect identification inference processing (S121), the identification inference unit 41 identifies whether the suspected defective portion is an actual defect using the defect identification model read from the defect identification model storage unit 43. The identification learning unit 42 learns defect images in advance using teacher data 104 for the defect images. The teacher data 104 for the defect images includes images of defects only, such as defect images 104a and 104b showing cracks or the like of different shapes. The identification learning unit 42 learns the defect images to update the defect identification model. A plurality of defect identification models, which are examples of trained models that have been trained for the respective structures, are stored in the defect identification model storage unit 43 (see FIG. 5). The identification inference unit 41 performs defect identification inference processing (S121) on the suspected defective portion in the input image 101, and outputs an identification result 106.

The identification result 106 indicates a result of identifying a defect with respect to the suspected defective portion by the identification inference unit 41 through the defect identification inference processing (S121). The defect identification model learns only shapes of defects. Therefore, if an image of a suspected defective portion has a shape different from the shape of the defect that has been learned, such as a scratch or a shadow caused by a deposit, the identification inference unit 41 identifies the input image 101 as being non-defective D11. Since the defect identification model has learned the crack that has actually occurred, the identification inference unit 41 identifies the input image 101 as being defective D12.

When the identification inference unit 41 identifies the input image 101 as being non-defective D11 by performing processing of identifying a suspected defective portion using the defect identification model, the identification inference unit 41 may output the input image 101 from which the emphasized portion 105 has been deleted to the annotation unit 5. Alternatively, the identification inference unit 41 may perform emphasis processing on this portion as a suspected defective portion identified by the identification inference unit 41, using a color different from the emphasis color added to the defective portion. In this case, a position where there is a difference between the original input image 101 and the restored image 103 determined to be non-defective is emphasized as a suspected defective portion by the identification inference unit 41.

On the other hand, when the identification inference unit 41 identifies the input image 101 as being defective D12, the input image 101 in which the emphasized portion 105 is left may be output to the annotation unit 5. Regardless of the identification result 106 by the identification inference unit 41, the input image 101 in which the emphasized portion 105 is left may be output to the annotation unit 5.

Referring back FIG. 5, the description will be made.

Using the defective portion data for teacher data D13 selected by the selection unit 60, the identification learning unit 42 learns the feature amount of the defect image and generates a defect identification model. The defective portion data for teacher data D13 is data input from the selection unit 60, and is obtained by using only defect images (referred to as defective portions) such as cracks as teacher data. When there is a defect identification model for an existing structure, this defect identification model is updated. The defect identification model is updated, for example, by changing the weights between layers in the neural network.

That is, the learning unit 8 illustrated in FIG. 1 includes an identification learning unit 42 that causes the defect identification model to learn the feature amount of the defective portion using the input image 101 to which the annotation information that the defect identification model has not learned is added as the defective portion data for teacher data.

The defect identification model storage unit 43 is an example of a database, and stores the defect identification model generated by the identification learning unit 42. As described above, the defect identification model stored in the defect identification model storage unit 43 is appropriately read by the identification inference unit 41 and used for identifying a defect.

Next, an example of an internal configuration of the annotation unit 5 and the inspector determination processing (S131) will be described. The inspector 6 visually checks the input image 101 from which a defect is detected and identified, and finally determines whether there is a defect.

Here, the inspector determination processing (S131) will be described.

FIG. 7 is a diagram illustrating an example of the inspector determination processing (S131) performed by the annotation unit 5.

In the inspector determination processing (S131), the input image 101 in which the emphasized portion 105 is added to the original input image 101 is used. The input image 101 to which the emphasized portion 105 is attached is displayed on a display device or the like, and the inspector 6 visually focuses on the emphasized portion 105 attached to the input image 101 and determines whether there is a defect. Thereafter, a determination result 107 is output.

The determination result 107 includes one of defective D21 or D25 and non-defective D23 or D27 added by the annotation unit 5 as will be described later. The input image 101 sent to the selection unit 60 and used for relearning is sorted depending on whether it is non-defective D21 or D25 or defective D23 or D27.

Referring back FIG. 5, the description will be made.

The annotation unit 5 includes a first labeling unit 51 and a second labeling unit 52. Each of the first labeling unit 51 and the second labeling unit 52 receives an input of an operation from the inspector 6 who attaches a label indicating a result of determining whether there is a defect while checking the input image 101 displayed on the screen, and generate a determination result 107 (see FIG. 7 to be described later).

The first labeling unit 51 performs labeling processing of attaching a label, which is a result of the inspector 6 recognizing the input image 101 identified by the identification inference unit 41 as being non-defective D11 and determining whether there is a defect in the input image 101, to the input image 101. In this labeling processing, a result of a visual determination made by the inspector 6 is attached to the input image 101. The input image 101 determined by the inspector 6 to be non-defective D21 using the first labeling unit 51 matches the result of the determination made to be non-defective D11 by the identification inference unit 41. Therefore, the identification inference unit 41 can correctly determine that the input image is non-defective D11, and determines that the input image is normal D22. In this case, it is considered that the feature amount learning unit 34 and the identification learning unit 42 use normally trained models, and therefore, the feature amount learning unit 34 and the identification learning unit 42 do not need to be retrained.

On the other hand, the input image 101 determined to be defective D23 by the first labeling unit 51 is different from the result of the determination made to be non-defective D11 by the identification inference unit 41. That is, the identification inference unit 41 erroneously determines that the input image 101 is non-defective D11. The reason why the identification inference unit 41 makes an erroneous determination is that the input image 101 is an image that has been unlearned D24 other than the images learned by the identification learning unit 42. As described above, when the identification results of the feature amount inference unit 31 and the identification inference unit 41 are different from the content of the label attached by the inspector 6, the feature amount learning unit 34 and the identification learning unit 42 are not able to learn correctly because there is no image of the corresponding portion in the teacher data during learning. Therefore, the first labeling unit 51 outputs, to the selection unit 60, the input image 101 to which a label (an example of annotation information) indicating that the input image 101 has been unlearned D24 by the trained model is attached.

The second labeling unit 52 determines whether there is a defect by the inspector 6 recognizing the input image 101 identified as being defective D12 by the identification inference unit 41, and attaches a label indicating this determination result to the input image 101. In this labeling processing as well, a result of a visual determination made by the inspector 6 is attached to the input image 101. The input image 101 determined to be non-defective D25 by the second labeling unit 52 is different from the result of the determination made to be defective D12 by the identification inference unit 41. That is, the identification inference unit 41 erroneously determines that the input image 101 is defective D12. The reason why the identification inference unit 41 makes an erroneous determination is that the input image 101 is an image that has been unlearned D26 other than the images learned by the identification learning unit 42. As described above, when the identification results of the feature amount inference unit 31 and the identification inference unit 41 are different from the content of the label attached by the inspector 6, the feature amount learning unit 34 and the identification learning unit 42 are not able to learn correctly because there is no image of the corresponding portion in the teacher data during learning. Therefore, the second labeling unit 52 outputs, to the selection unit 60, the input image 101 to which a label (an example of annotation information) indicating that the input image 101 has been unlearned D26 by the trained model is attached.

On the other hand, the input image 101 determined by the inspector 6 to be defective D27 using the second labeling unit 52 is the same as the result of the determination made to be defective D12 by the identification inference unit 41. Therefore, the identification inference unit 41 can correctly determine that the input image is defective D12, and determines that the input image is normal D28. In this case, it is considered that the feature amount learning unit 34 and the identification learning unit 42 use normally trained models, and therefore, the feature amount learning unit 34 and the identification learning unit 42 do not need to be retrained.

The selection unit 60 selects whether to add the input image 101 to either or both of the teacher data used for training the feature amount learning unit 34 and the teacher data used for the identification learning unit 42 according to a determination of the engineer 61 illustrated in FIG. 3. For example, when the input image 101 determined to be defective D1 by the defect detection unit 30 is determined to be defective D12 by the defect identification unit 40 and is determined to be non-defective D25 by the annotation unit 5, the input image 101 has been unlearned D26 by the defect detection model and the defect identification model. Therefore, the selection unit 60 adds the input image 101 to the sound portion data for teacher data D4 and the defective portion data for teacher data D13.

In addition, when the input image 101 determined to be defective D1 by the defect detection unit 30 is determined to be non-defective D11 by the defect identification unit 40 and is determined to be defective D23 by the annotation unit 5, the determination results of the defect detection unit 30 and the annotation unit 5 are the same. However, the determination results of the defect identification unit 40 and the annotation unit 5 are different. Therefore, the selection unit 60 adds the input image 101 to the defective portion data for teacher data D13.

The input image 101 is input as learning data to each of the feature amount learning unit 34 and the identification learning unit 42 selected by the selection unit 60 for relearning. Then, the feature amount learning unit 34 and the identification learning unit 42 perform progressive relearning.

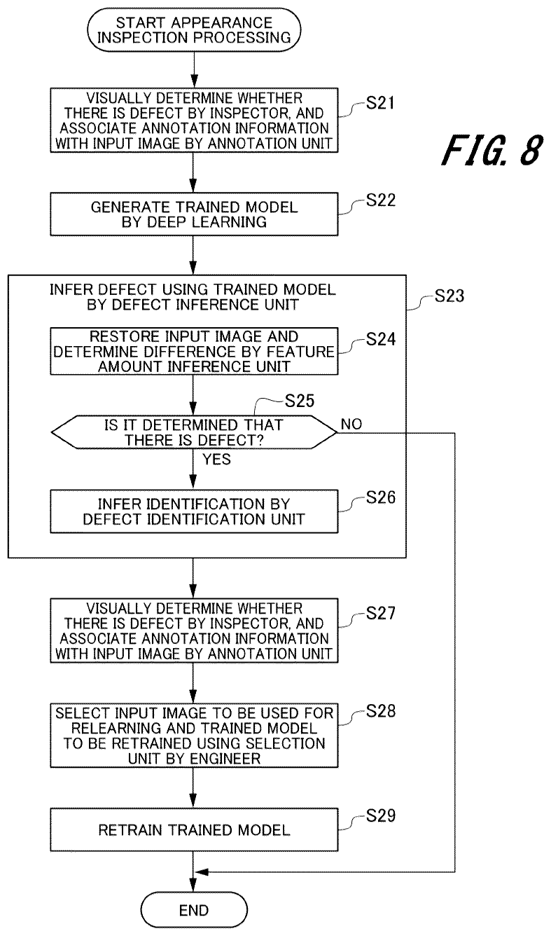

FIG. 8 is a flowchart illustrating an example of appearance inspection processing performed by the appearance inspection apparatus 10 according to the first embodiment. The appearance inspection processing illustrated in FIG. 8 is an aspect of the appearance inspection method according to the present invention, and the details of the processing will be described mainly with reference to FIGS. 1, 2, 3, and 5.

First, in order to generate a trained model, the inspector 6 visually determines whether there is a defect in an input image 2, and the annotation unit 5 associates annotation information with the input image 2 (S21). The input image 2 associated with the annotation information is used as the teacher data 7 illustrated in FIG. 1.

Next, the learning unit 8 reads the teacher data 7 and generates a trained model by deep learning (S22). In the defect detection unit 30, the feature amount learning unit 34 reads sound portion data for teacher data D4 and generates a defect detection model. In the defect identification unit 40, the identification learning unit 42 reads defective portion data for teacher data D13 and generates a defect identification model.

Next, the defect inference unit 3 infers a defect in the input image 2 using the trained model (S23). In the defect inference unit 3, processing of the defect detection unit 30 and the defect identification unit 40 is performed.

As illustrated in FIG. 4, the feature amount inference unit 31 of the defect detection unit 30 restores the input image 101 using the defect detection model using the restoration unit 32, and determines a difference between the input image 101 and the restored image 103 using the difference determination unit 33 (S24).

Next, the difference determination unit 33 determines whether there is a defect (S25). When the difference determination unit 33 determines that there is no defect (NO in S25), this processing ends. When the difference determination unit 33 determines that there is a defect (YES in S25), the identification inference unit 41 of the defect identification unit 40 infers the identification of the defect in the input image 101 using the defect identification model as illustrated in FIG. 5 (S26).

Next, the inspector 6 visually determines whether there is a defect in an input image 2, and the annotation unit 5 associates annotation information with the input image 2 (S27).

Next, the engineer 61 selects an input image 101 to be used for relearning and a trained model to be retrained using the selection unit 60 (S28), and the feature amount learning unit 34 and the identification learning unit 42 relearn the trained models (S29), and this processing ends. The input image 101 to be used for relearning is the teacher data 7 illustrated in FIG. 1. The trained models to be retrained are the defect detection model in the defect detection unit 30 and the defect identification model in the defect identification unit 40.

### Example of Hardware Configuration of Computer

Next, a hardware configuration of a computer 70 constituting the appearance inspection apparatus 10 will be described.

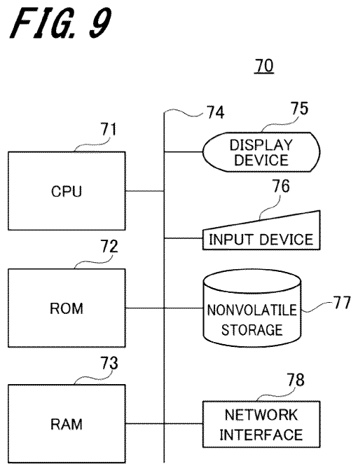

FIG. 9 is a block diagram illustrating an example of a hardware configuration of the computer 70. The computer 70 is an example of hardware used as a computer operable as the appearance inspection apparatus 10 according to the present embodiment. In the appearance inspection apparatus 10 according to the present embodiment, each functional block is configured by the computer 70 (computer) executing a program, and the functional blocks work together to realize the appearance inspection method according to the present embodiment.

The computer 70 includes a central processing unit (CPU) 71, a read only memory (ROM) 72, and a random access memory (RAN) 73, each of which is connected to a bus 74. The computer 70 further includes a display device 75, an input device 76, a nonvolatile storage 77, and a network interface 78.

The CPU 71 reads a program code of software for realizing each function according to the present embodiment from the ROM 72, loads the program code into the RAM 73, and executes the program code. Variables, parameters, and the like generated during the calculation processing of the CPU 71 are temporarily written in the RAM 73, and these variables, parameters, and the like are appropriately read by the CPU 71 to realize the processing of each functional unit according to the first embodiment. However, a micro processing unit (MPU) or a graphics processing unit (GPU) may be used instead of the CPU 71, or the CPU 71 and the graphics processing unit (GPU) may be used in combination.

The display device 75 is, for example, a liquid crystal display monitor, and displays a result of processing performed by the computer 70 and data (input image 101, restored image 103, identification result 106, determination result 107, and the like) that is a source of the processing to the inspector 6. As the input device 76, for example, a keyboard, a mouse, or the like is used, enabling the inspector 6 to input predetermined operations and give instructions.

As the nonvolatile storage 77, for example, a hard disk drive (HDD), a solid state drive (SSD), a flexible disk, an optical disk, a magneto-optical disk, a CD-ROM, a CD-R, a magnetic tape, a nonvolatile memory, or the like is used. In addition to an operating system (OS) and various parameters, programs for causing the computer 70 to function is recorded in the nonvolatile storage 77. In the nonvolatile storage 77, the defect detection model storage unit 35, the defect identification model storage unit 43, and the like are constructed. Programs, data, and the like required for the CPU 71 to operate are recorded in the ROM 72 and the nonvolatile storage 77. That is, the ROM 72 and the nonvolatile storage 77 are used as examples of non-transitory computer-readable storage media storing programs to be executed by the computer 70.

As the network interface 78, for example, a network interface card (NIC) or the like is used. The network interface 78 can transmit and receive various types of data between devices via a local area network (LAN), a dedicated line, or the like connected to a terminal of the NIC.

In the appearance inspection apparatus 10 according to the first embodiment described above, the learning unit 8 illustrated in FIG. 1 is divided into two units, the feature amount learning unit 34 and the identification learning unit 42, making it possible to select each of the feature amount learning unit 34 and the identification learning unit 42 to perform learning. Therefore, defect detection and defect identification using the defect detection model and the defect identification model subjected to machine learning in advance are automatically performed with respect to an input image 101 including a structure.

Conventionally, the inspector 6 visually checks a large number of input images 101. However, in the appearance inspection apparatus 10 according to the first embodiment, only an input image 101 including a suspected defective portion is automatically selected from among the large number of input images 101. In addition, the inspector 6 only needs to visually checks only the selected input image 101 and determine whether there is a defect, so that the burden on the inspector 6 is greatly reduced. Such an appearance inspection apparatus 10 can be incorporated as a part of an appearance inspection system useful for assisting the inspector 6 in appearance inspection.

In addition, an input image 101 for which a defect detection and identification result by AI is different from a result of determining whether there is a defect by the inspector 6 is selected as a target for relearning. Therefore, the feature amount learning unit 34 and the identification learning unit 42 are retrained, so that the defect detection model and the defect identification model are progressively updated. The accuracy of the feature amount inference unit 31 and the identification inference unit 41 using the defect detection model and the defect identification model in detecting and identifying a defect can be improved as compared with that of the conventional defect detection model and defect identification model. Therefore, the appearance inspection apparatus 10 can obtain a highly reliable defect detection and identification result.

### Second Embodiment

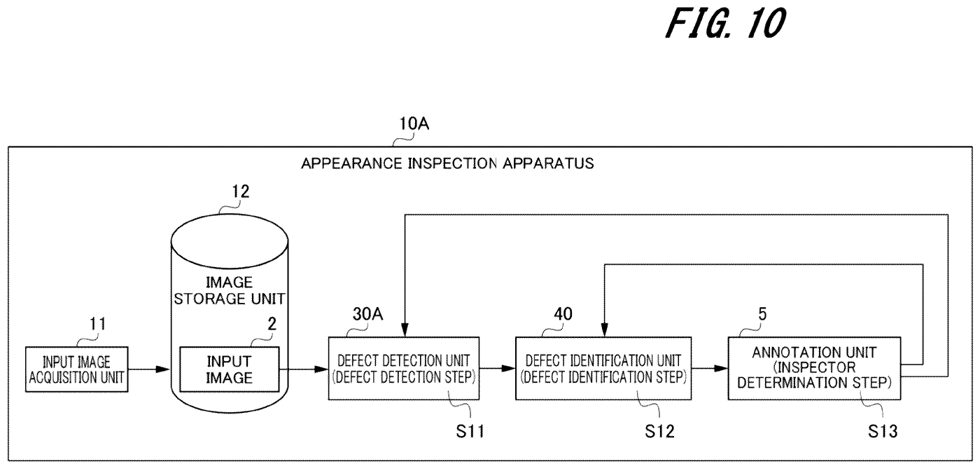

Next, an example of a configuration and an example of an operation of an appearance inspection apparatus 10A according to the second embodiment of the present invention will be described with reference to FIGS. 10 to 13.

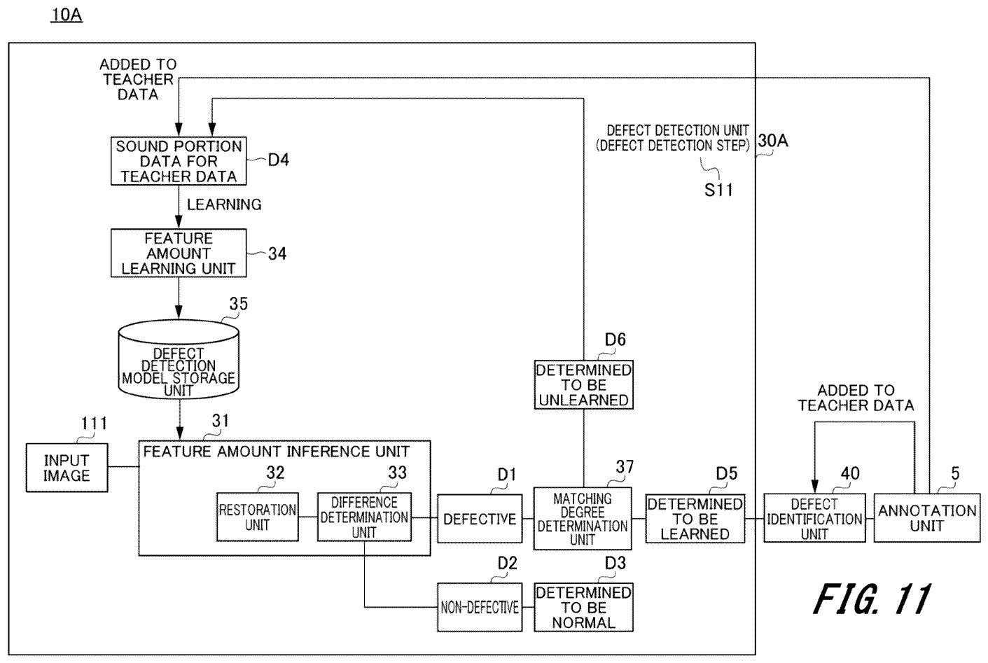

The appearance inspection apparatus 10A according to the second embodiment is an invention in which a matching degree determination unit 37 (see FIG. 11) is added to the defect detection unit 30 according to the first embodiment to more efficiently perform progressive learning of the feature amount learning unit 34 and the identification learning unit 42. The differences from the first embodiment will be described below.

FIG. 10 is a block diagram illustrating an example of an internal configuration of the appearance inspection apparatus 10A.

The appearance inspection apparatus 10A includes an input image acquisition unit 11, an image storage unit 12, a defect detection unit 30A, a defect identification unit 40, and an annotation unit 5. The appearance inspection apparatus 10A does not include the selection unit 60 according to the first embodiment, and can automatically input learning data to be relearned by the defect detection unit 30A and the defect identification unit 40.

FIG. 11 is a block diagram illustrating an example of an internal configuration of the defect detection unit 30A. The defect detection unit 30A includes a matching degree determination unit 37 in addition to each unit of the defect detection unit 30 according to the first embodiment.

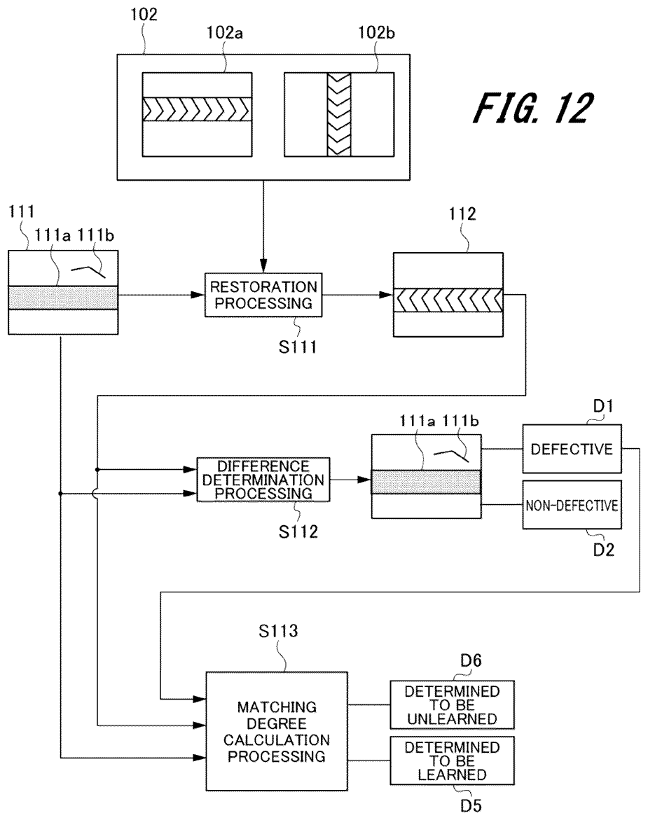

As illustrated in FIG. 11, an input image 111 determined to be defective D1 through the processing performed by the restoration unit 32 and the difference determination unit 33 of the feature amount inference unit 31 is input to the matching degree determination unit 37. Note that the input image 111 is one image read from among the plurality of input images 2 stored in the image storage unit 12. The matching degree determination unit 37 determines a matching degree between the input image 111 determined to be defective D1 and a restored image 112 (see FIG. 12 to be described later). The matching degree determination unit 37 determines an input image 101 whose matching degree is lower than a threshold (e.g., 20%) to be unlearned, and causes the defect detection model to learn the feature amount of the sound portion using the input image 101 determined to be unlearned as the sound portion data for teacher data. On the other hand, the matching degree determination unit 37 determines an input image 101 whose matching degree is equal to or higher than the threshold to be learned, and outputs the input image 101 determined to be learned to the defect identification unit 40.

Here, the matching degree determination processing (S113) will be described with reference to FIG. 12.

FIG. 12 is a diagram that outlines the image restoration processing, difference determination processing, and matching degree calculation processing performed by the defect detection unit 30A according to the second embodiment. All of the restoration unit 32, the difference determination unit 33, and the matching degree determination unit 37 can execute the defect detection step (S11) in combination with the defect detection model.

The input image 111 is a flaw detection image that is not included in the teacher data 102. The input image 111 includes an image of a pattern 111a and an image of a crack 111b.

In the restoration unit 32, restoration processing (S111) is performed by machine learning, for example, using an auto encoder or the like. As a result of performing the restoration processing based on the image 102a included in the teacher data 102, the restoration unit 32 outputs a restored image 112 including a pattern of a welding line. The image of the pattern 111a included in the input image 111 has been unlearned by the feature amount learning unit 34. Therefore, the restored image 112 output after the restoration processing (S111) is greatly different from the original input image 111.

The difference determination unit 33 performs difference determination processing (S112) of determining a difference between the restored image 112 output by the restoration unit 32 and the input image 111 before the image restoration processing. The difference determination unit 33 determines the image to be defective D1 when there is a difference in the image, and determines the image to be non-defective D2 when there is no difference in the image. In this example, the difference between the input image 111 and the restored image 112 is indicated as a pattern 111a or a crack 111b, and it is determined whether there is a defect.

The matching degree determination unit 37 performs matching degree calculation processing (S113) of calculating a matching degree by comparing the restored image 112 determined to be defective D1 with the input image 111 before the image restoration processing, in order to determine whether the feature amount learning unit 34 has already learned the structure in the input image 111. The matching degree is calculated, for example, by performing monochrome conversion on each image, calculating the number of matches of luminance in each pixel, and calculating a ratio of the number of pixels to the entire image. The process can be set, for example, such that the matching degree is considered high when the ratio is 20% or more and is considered low when the ratio is less than 20%. This threshold is set by an internal processing operation.

When the teacher data 102 of structure-captured images includes a structure appearing in the input image 111, the matching degree is high, and when the teacher data 102 of structure-captured images does not include a structure appearing in the input image 111, the matching degree is low. Alternatively, when the pattern 102a of each structure appearing in the teacher data 102 matches the pattern 111a appearing in the input image 111, the matching degree is high, and when the pattern 102a of each structure appearing in the teacher data 102 does not match the pattern 111a appearing in the input image 111, the matching degree is low. In the example of FIG. 12, since it is assumed that the input image 111 is a flaw detection image of a structure that is not included in the teacher data 102, a result indicating a low matching degree is output.

When the matching degree determination unit 37 determines that the matching degree is low, the input image 111 is determined to be unlearned D6. Since the input image 111 has not been learned by the feature amount learning unit 34, the input image 111 is added to the teacher data 102 of the feature amount learning unit 34. On the other hand, the matching degree determination unit 37 passes the input image 111 determined to be learned D5 in the determination of the matching degree to subsequent processing (steps (S12 and S13) according to first embodiment). Note that the input image 111 determined to be learned D5 is labeled as “learned”, and if this input image 111 is additionally learned by the feature amount learning unit 34, over-learning may occur.

As described with reference to FIG. 5, the defect identification step (S12) and the inspector determination step (S13) are performed on the input image 111.

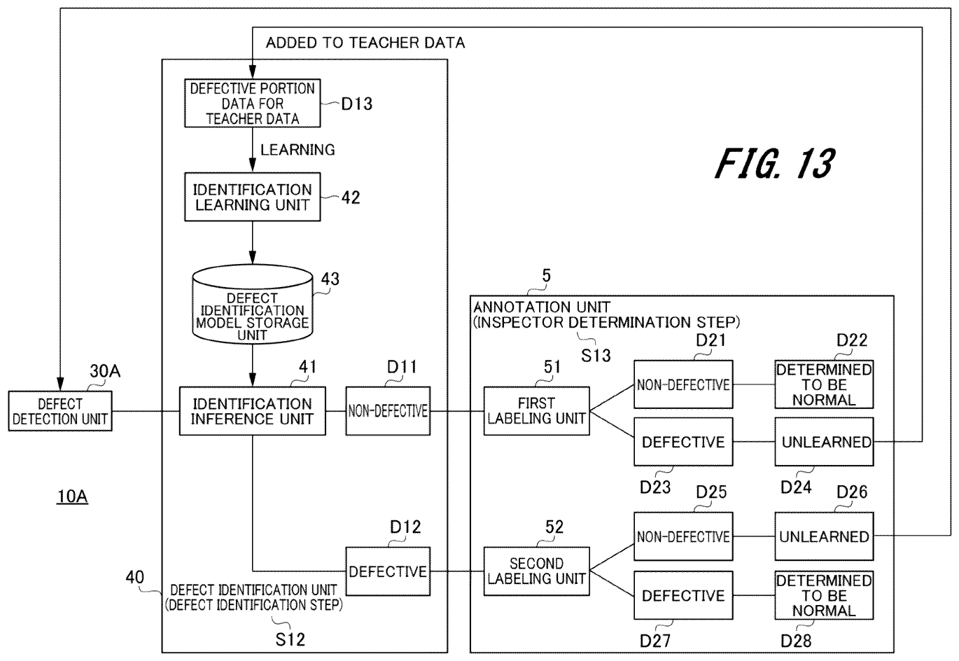

FIG. 13 is a block diagram illustrating examples of detailed internal configurations of the defect identification unit 40 and the annotation unit 5.

The blocks for the defect identification unit 40 and the annotation unit 5 according to the second embodiment are the same as the blocks for the defect identification unit 40 and the annotation unit 5 according to the first embodiment illustrated in FIG. 5. When the result of the determination made by the identification inference unit 41 in the defect identification processing (S12) is different from the result of the determination made by the inspector 6 in the inspector determination processing (S13), each learning unit is additionally trained.

For example, an input image 111 determined to be non-defective D11 by the identification inference unit 41 and then determined to be defective D23 by the first labeling unit 51 of the annotation unit 5, and labeled as unlearned D24 contains a defective portion. The input image 111 is added to the defective portion data for teacher data D13 of the identification learning unit 42, and is learned by the identification learning unit 42.

On the other hand, an input image 111 determined to be defective D12 by the identification inference unit 41 and then determined to be non-defective D25 by the second labeling unit 52 of the annotation unit 5 is an image of a sound portion, and is unlearned data. Therefore, the input image 111 labeled as unlearned D26 is added to the sound portion data for teacher data D4 illustrated in FIG. 11, and is learned by the feature amount learning unit 34.

By using this method, the feature amount learning unit 34 and the identification learning unit 42 can efficiently perform progressive learning. In the appearance inspection apparatus 10A according to the second embodiment, step S28 is removed from the flowchart illustrated in FIG. 8. Therefore, the description of the flowchart of the appearance inspection apparatus 10A is omitted.

In the appearance inspection apparatus 10A according to the second embodiment described above, an input image 111 determined to be unlearned D6 by the matching degree determination unit 37 included in the defect detection unit 30A is to be relearned by the feature amount learning unit 34. When a result of a determination made by the defect identification unit 40 as to whether there is a defect is different from a result of a determination made by the annotation unit 5 as to whether there is a defect, an input image 111 determined to be learned D5 by the matching degree determination unit 37 is to be re-learned by the feature amount learning unit 34 or the identification learning unit 42 corresponding thereto. The inspector 6 does not need to determine whether to cause the feature amount learning unit 34 or the identification learning unit 42 to read the input image 111 to be relearned. Therefore, the feature amount learning unit 34 and the identification learning unit 42 can perform progressive learning that does not depend on a human. In addition, the inspector 6 does not need to select an input image 111 to be relearned, so that the burden on the inspector 6 is reduced, and the time required for progressive learning is also shortened.

The input image 111 to be relearned is unlearned data. Therefore, the feature amount learning unit 34 and the identification learning unit 42 can be prevented from over-learning using already learned data.

### [Modifications]

In each of the above-described embodiments, a case where the appearance inspection apparatus 10 or 10A is used for an appearance inspection of a structure in a nuclear power plant has been described. However, the appearance inspection apparatus 10 or 10A can also be used in a hydraulic power plant or a thermal power plant as well as the nuclear power plant, and for railway track maintenance work.

Although the appearance inspection apparatus 10 or 10A has been described as one apparatus, the functional units constituting the appearance inspection apparatus 10 or 10A may be configured as different apparatuses. For example, the defect detection unit 30, the defect identification unit 40, and the annotation unit 5 may be configured as different apparatuses or cloud applications, and an appearance inspection system may be configured by integrating these functional units into one.

Furthermore, the first labeling unit 51 and the second labeling unit 52 included in the annotation unit 5 may be replaced with, for example, a defect determination model subjected to machine learning to operate without an operation performed by the inspector 6.

In addition, by using the appearance inspection apparatus 10A according to the second embodiment, the performances of the defect detection model and the defect identification model may change during the inspection period in which the appearance inspection is performed, and the output results of the models may also change before and after the performance change. Therefore, during the inspection period in which the appearance inspection is performed using the appearance inspection apparatus 10 according to the first embodiment, the execution of the selection step (S14) by the selection unit 60 is awaited. After the inspection period ends, the defect detection model and the defect identification model are progressively trained by executing the selection step (S14) illustrated in FIG. 2. The appearance inspection using the defect detection model and the defect identification model after being retrained may be performed in a place different from the structure for which the appearance inspection has been performed.

Note that it goes without saying that the present invention is not limited to the above-described embodiments, and various other applications and modifications can be taken without departing from the gist of the present invention set forth in the claims.

For example, the above-described embodiments describe the configurations of the apparatus and the system in detail and specifically in order to explain the present invention in an easy-to-understand manner, and are not necessarily limited to those having all the configurations described above. In addition, a part of the configuration of one embodiment described here can be replaced with the configuration of another embodiment, and furthermore, the configuration of one embodiment can be added to the configuration of another embodiment. In addition, other configurations may be added to, deleted from, or substituted for a part of the configuration of each of the embodiments.

In addition, control lines and information lines considered necessary for explanation are shown, and not all control lines and information lines on a product are necessarily shown. In practice, it may be considered that almost all the configurations are connected to each other.

What is claimed is:

1. An appearance inspection system comprising:
an annotation unit configured to associate annotation information indicating whether a defect of a structure is normal with an input image to be used for an appearance inspection of the structure, the annotation information being determined by a user based on the input image;
a learning unit configured to generate a trained model by deep learning using the annotation information and the input image associated with the annotation information with respect to an initially-set trained model; and
a defect inference unit configured to output an inference result obtained by inferring the defect based on the input image using the trained model generated by the learning unit,
wherein the annotation unit associates the annotation information with the input image for which the inference result is different from a result of the determination made by the user for the input image to cause the learning unit to relearn the trained model.

2. The appearance inspection system according to claim 1, wherein
the defect inference unit includes:
a defect detection unit by which the trained model detects the defect of the structure based on the input image; and
a defect identification unit by which the trained model identifies whether there is the defect based on the input image determined to have the defect by the defect detection unit, and
the annotation unit associates the annotation information with the input image when a result of the user recognizing the input image and associating whether there is the defect is different from the defect identified by the defect identification unit.

3. The appearance inspection system according to claim 2, wherein
the defect detection unit includes a feature amount inference unit including a restoration unit configured to output a restored image restored from the input image based on sound portion data for teacher data including a sound portion where the defect is not present, and a difference determination unit configured to determine a difference between the input image and the restored image, and configured to detect the defect from the input image based on the difference.

4. The appearance inspection system according to claim 3, wherein
the defect detection unit detects the defect using a defect detection model that detects the defect as the trained model, and
the learning unit includes a feature amount learning unit configured to cause the defect detection model to learn a feature amount of the sound portion by using, as the sound portion data for teacher data, the input image to which the annotation information that has not been learned by the defect detection model is added.

5. The appearance inspection system according to claim 4, wherein
the defect identification unit includes an identification inference unit configured to identify the defect in the input image determined to have the defect based on defective portion data for teacher data including a defective portion where the defect is present, and associate the annotation information indicating whether there is the defect with the input image.

6. The appearance inspection system according to claim 5, wherein
the defect identification unit detects the defect using a defect identification model that identifies the defect as the trained model, and
the learning unit includes an identification learning unit configured to cause the defect identification model to learn a feature amount of the defective portion by using, as the defective portion data for teacher data, the input image to which the annotation information that has not been learned by the defect identification model is added.

7. The appearance inspection system according to claim 6, wherein
the annotation unit includes:
a first labeling unit configured to attach, to the input image identified as being non-defective by the identification inference unit, a label that is a result of the user recognizing the input image and determining whether there is the defect; and
a second labeling unit configured to attach, to the input image identified as being defective by the identification inference unit, a label that is a result of the user recognizing the input image and determining whether there is the defect,
the first labeling unit associates the annotation information that has not been learned by the trained model with the input image determined to be defective, and
the second labeling unit associates the annotation information that has not been learned by the trained model with the input image determined to be non-defective.

8. The appearance inspection system according to claim 7, further comprising:
a selection unit by which the user selects the input image to be learned by at least one of the feature amount learning unit and the identification learning unit, and the feature amount learning unit and the identification learning unit to learn the input image based on the annotation information associated with the input image.

9. The appearance inspection system according to claim 4, wherein
the defect detection unit includes a matching degree determination unit configured to determine a matching degree between the input image determined to be defective by the feature amount inference unit and the restored image, determine the input image whose matching degree is lower than a threshold to be unlearned, cause the defect detection model to learn a feature amount of the sound portion using the input image determined to be unlearned as the sound portion data for teacher data, determine the input image whose matching degree is equal to or higher than the threshold to be learned, and output the input image determined to be learned to the defect identification unit.

10. The appearance inspection system according to claim 6, further comprising:
an input image acquisition unit configured to acquire the input image from an imaging unit that images the structure;
an input image storage unit configured to store a plurality of the input images acquired by the input image acquisition unit in such a manner as to be readable by the defect detection unit; and
a model selection unit configured to select the defect detection model and the defect identification model to be used for the appearance inspection for each of the structures,
wherein the defect detection unit includes a defect detection model storage unit configured to store a plurality of the defect detection models, and
the defect identification unit includes a defect identification model storage unit configured to store a plurality of the defect identification models.

11. An appearance inspection method comprising:
associating annotation information indicating whether a defect of a structure is normal with an input image to be used for an appearance inspection of the structure, the annotation information being determined by a user based on the input image;
generating a trained model by deep learning using the annotation information and the input image associated with the annotation information with respect to an initially-set trained model;
outputting an inference result obtained by inferring the defect based on the input image using the generated trained model; and
relearning the trained model by associating the annotation information with the input image for which the inference result is different from a result of the determination made by the user for the input image.
